(19) United States
(12) Patent Application Publication
(10) Pub. No.: US 2006/0041209 A1
(43) Pub. Date: Feb. 23, 2006

(54) Release type massager

(76) Inventor: Shan-Chi Ko, Hualien County (TW)

Correspondence Address: BACON & THOMAS, PLLC, 625 SLATERS LANE, FOURTH FLOOR, ALEXANDRIA, VA, 22314, US

(21) Appl. No.: 11/204,014

(22) Filed: Aug. 16, 2005

(30) Foreign Application Priority Data
Aug. 20, 2004 (TW) 93213372

(51) Int. Cl. A61H 7/00

(52) U.S. Cl. 601/15; 601/21; 601/137

(57) ABSTRACT

A massager is disclosed to include a receiving barrel has a barrel body, a receiving hole axially formed inside of the barrel body, a massage head formed at front end of the barrel body, a plurality of release holes radially and equiangularly throughout the barrel body, the release holes are nearby the massage head with a predetermine distance; an ion generating device has a main body of circular cylinder mounted inside the receiving hole of the receiving barrel, an ion generating end nearby the release holes of the receiving barrel.

### BACKGROUND OF THE INVENTION

1. Field of the Invention

The present invention relates to massagers and more particularly, to a massager with releasing element.

2. Description of the Related Art

Conventional massager usually has a bar used to press human body for achieve releasing pains and other functions. Further, for more functions, the operator will take an ion generation device nearby the massager, therefore the user must held the massager at one hand and the ion generation device at another hand, therefore cause difficult to operating; Moreover, the distance of ion generation device will variable by user's hand and causing the ions cannot have a constant distance applied to human body. And the ion generation device must conduct an electric power, the user cannot use in the place without power supply.

### SUMMARY OF THE INVENTION

The present invention has been accomplished under the circumstances in view. It is the main object of the present invention to provide a massager, which combines ion releasing means and massager, the ions can be released during operation of the massager. It is another object of the present invention to provide a massager, which has a simple structure that is easy to install and to operate.

To achieve these and other objects of the present invention, the massager comprising: a receiving barrel having a barrel body, a receiving hole axially formed inside of the barrel body, a massage head formed at front end of the barrel body, a plurality of release holes radially and equiangularly throughout the barrel body, the release holes are nearby the massage head with a predetermine distance; an ion generating device having a main body of circular cylinder mounted inside the receiving hole of the receiving barrel, an ion generating end nearby the release holes of the receiving barrel.

### BRIEF DESCRIPTION OF THE DRAWINGS

FIG. 1 is a schematic drawing showing a massager according to the present invention.

FIG. 2 is an exploded elevational view of the massager according to the present invention.

FIG. 3 is an exploded elevational view of an alternate form of massager according to the present invention.

FIG. 4 is a sectional assembly view of another structure of the releasing holes according to the present invention.

FIG. 5 is a sectional assembly view of still another structure of the releasing holes according to the present invention.

FIG. 6 is a sectional assembly view of still another structure of the releasing holes according to the present invention.

FIG. 7 is a sectional assembly view of still another massager according to the present invention.

FIG. 8 is a sectional assembly view of still another massager according to the present invention.

### DETAILED DESCRIPTION OF THE INVENTION

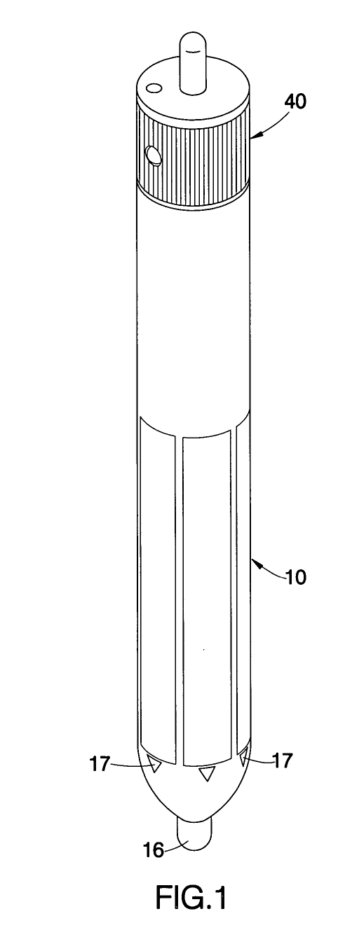

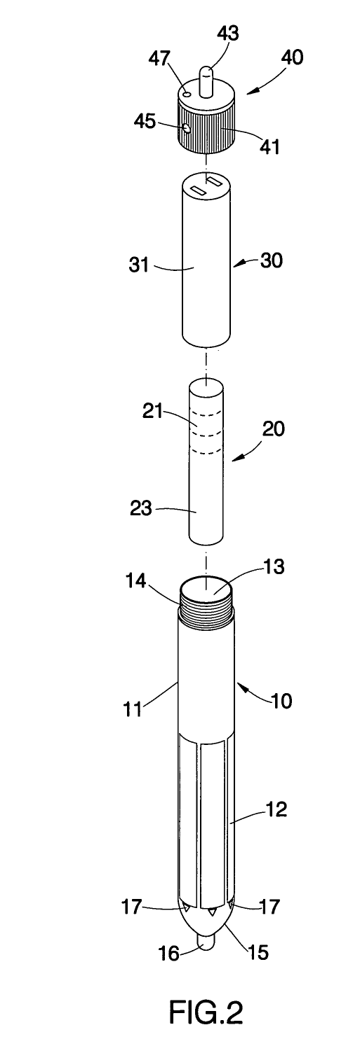

Referring to FIG. 1 and FIG. 2, a massager of a preferred embodiment of the present invention comprises:

A receiving barrel 10 has a barrel body 11 of cylinder shape, a handheld portion 12, a receiving hole 13 axially formed inside of the barrel body 11, a cover fitting portion 14, a control button 15, a massage head 16 formed at front end of the barrel body 11, a plurality of release holes 17 radially and equiangularly throughout the barrel body 11, the release holes 17 are nearby the massage head 16 with a predetermine distance.

An ion generating device 20 has a main body 21 of circular cylinder mounted inside the receiving hole 13 of the receiving barrel 10, an ion generating end 23 nearby the release holes 17 of the receiving barrel 10.

A power unit 30 has a plurality of battery 31 of circular cylinder shape and mounted inside the receiving hole 13 of the receiving barrel 10, the power unit 30 is electrically connected to the ion generating device 20.

A control device 40 has a cover 41 assembled to the cover fitting portion 14 of the receiving barrel 10, a control switch 43, an indicating light 45; the control device 40 further has an electric conducting portion 47 for conducting electric.

Referring to FIG. I and FIG. 2 again, using one hand to hold the massager and let the massage head 16 of the receiving barrel 10 pressed on the surface of the skin of the human, and can let the massager swingly operated.

Further, press the control switch 43 of the control device 40 by the thumb to let the power unit 30 conducted and providing electric to the ion generating device 20, therefore the ion generating device 20 generating ion at its ion generating end 23 and released out through the release holes 17 of the receiving barrel 10, wherein the release holes 17 of the receiving barrel 10 are nearby the massage head 16, therefore the released ion is nearly contact to the skin of the human.

Whereby the user does not need hold two devices at each hand but can hold and operated by one hand conveniently; further, the ion released from are nearby the massage portion of human body and has a constant distance providing better and stability operating effect.

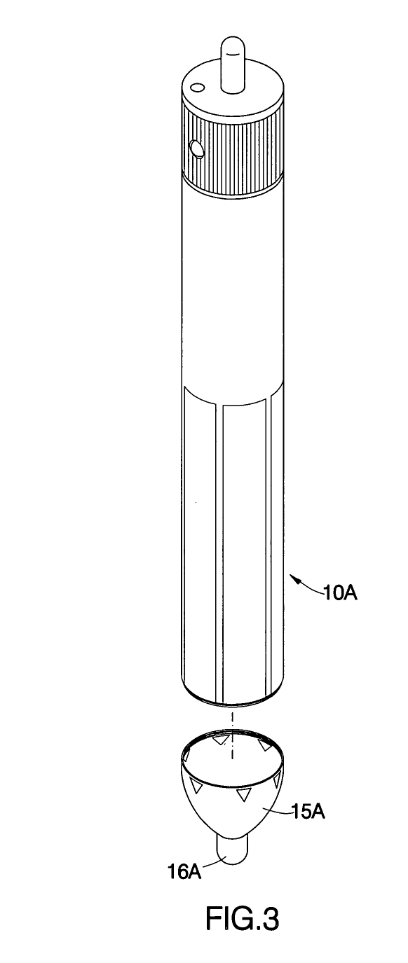

Referring to FIG. 3, an alternate form of the present invention as shown, wherein the control button 15A and massage head 16A of the receiving barrel 10A are formed integrated as a part and can be assembled to the receiving barrel 10A by means of the threading, glue sticking or welding etc; wherein the release holes can be formed at either the receiving barrel 10A or the control button 15A in this embodiment.

Further, the massage head of aforesaid embodiments can be the shape of circular cylinder, cone, triangular or semicircular.

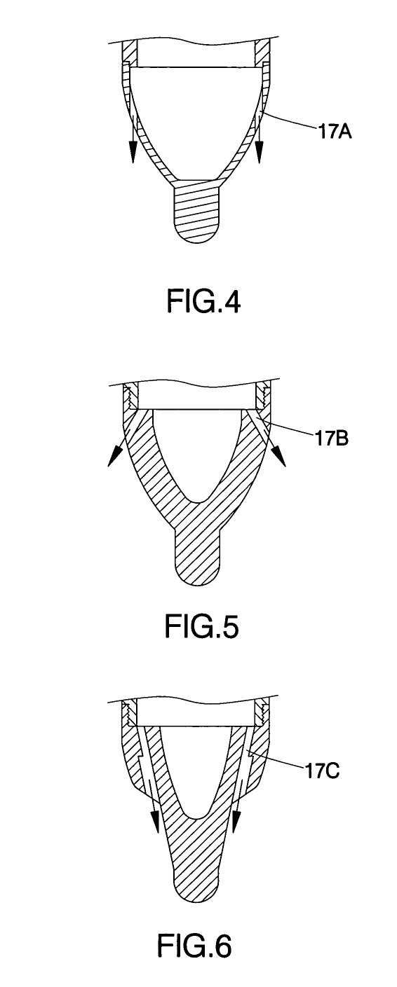

Referring to FIGS. 4 to 6, an alternate form of the present invention as shown, wherein the release holes 17A are formed parallel to the axial centerline of the receiving barrel, another release holes 17B are formed radially outwardly to the axial centerline of the receiving barrel, still another release holes 17C are formed radially inwardly to the axial centerline of the receiving barrel, therefore providing different releasing area.

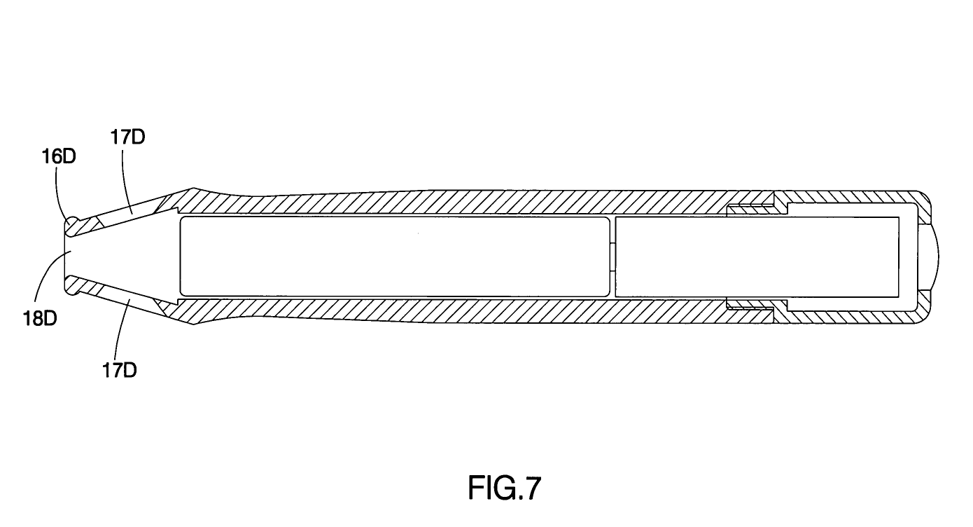

Referring to FIG. 7, an alternate form of the present invention as shown, wherein the release holes 17D of the receiving barrel are formed flaring shape, the receiving barrel further has a second release hole 18D formed at an end of the receiving barrel and let the massage head 16D formed a pipe opening which also achieve objective and functions of the present invention.

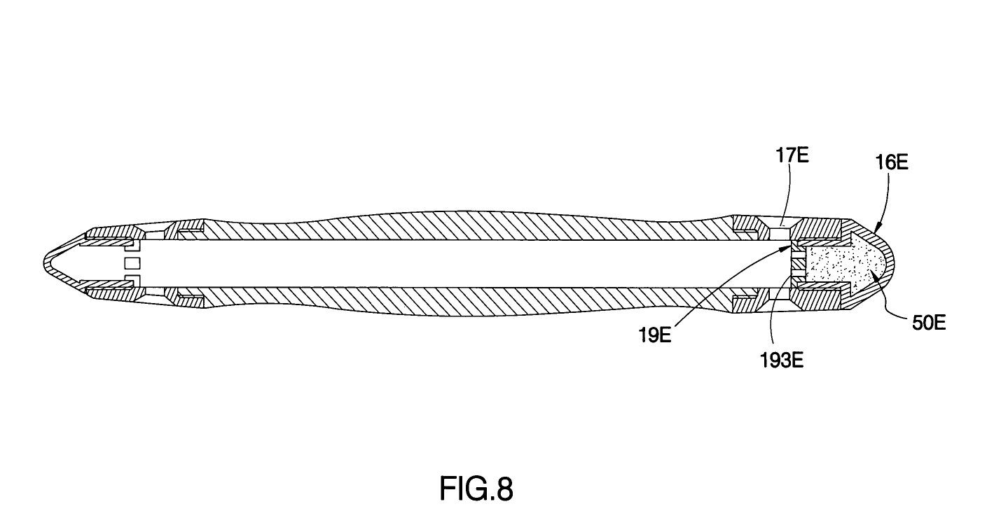

Referring to FIG. 8, an alternate form of the present invention as shown, wherein the massage head 16E is assembled and load a plurality of fungus 50E, the massage head 16E further has an isolating cover 19E bored with a plurality of transverse hole 193E providing the fungus 50E released by.

As indicated above, the invention provides a massager, which has the following advantages:

1. The massager combines ion releasing means and massager, the ions can be released during operation of the massager.

2. The massager combines ion releasing means and massager, the ions can be released near around the massage head and providing good releasing effect.

3. The massager has a simple structure that is easy to install and to operate.

What is claimed is:

1. A massager comprising:
a receiving barrel having a barrel body, a receiving hole axially formed inside of said barrel body, a massage head formed at front end of said barrel body, a plurality of release holes radially and equiangularly throughout said barrel body, said release holes are nearby said massage head with a predetermine distance;
an ion generating device having a main body of circular cylinder mounted inside said receiving hole of said receiving barrel, an ion generating end nearby said release holes of said receiving barrel.

2. The massager as claimed in claim 1, wherein said release holes are formed parallel, radially outwardly or radially inwardly to the axial centerline of said receiving barrel.

3. The massager as claimed in claim 1, wherein said receiving barrel further has a second release hole formed at an end of said receiving barrel and let said massage head formed a pipe opening.

4. A massager comprising:
a receiving barrel having a barrel body of cylinder shape, a receiving hole axially formed inside of said barrel body, a massage head formed at front end of said barrel body, a plurality of release holes radially and equiangularly throughout said barrel body, said release holes are nearby said massage head with a predetermine distance, and a plurality of fungus loaded inside said massage head.

5. The massager as claimed in claim 4, wherein said receiving barrel further has an isolating cover for covering inside of said massage head.
